(19) United States
(12) Patent Application Publication
(10) Pub. No.: US 2022/0256437 A1
(43) Pub. Date: Aug. 11, 2022

(54) BASE STATION, USER EQUIPMENT, AND RELATED METHOD

(71) Applicant: SHARP KABUSHIKI KAISHA, Sakai City, Osaka (JP)

(72) Inventor: FANGYING XIAO, Shanghai (CN)

(21) Appl. No.: 17/606,188

(22) PCT Filed: Apr. 26, 2020
(86) PCT No.: PCT/CN2020/086977

§ 371 Date: Oct. 25, 2021

(30) Foreign Application Priority Data
Apr. 28, 2019 (CN) 201910352995.0

(51) Int. Cl. H04W 48/02; H04W 76/20; H04W 76/15

(52) U.S. Cl. CPC H04W 48/02; H04W 76/15; H04W 76/20

(57) ABSTRACT

Provided in the present disclosure is a method in user equipment, the method comprising: receiving an RRC message for a cell restricted for a logical channel associated with a packet duplication bearer, wherein the cell restricted for the logical channel associated with the packet duplication bearer is indicated by an indicator of a data type of a bit string, the least significant bit of the bit string corresponds to a serving cell with index 0, and the next bit corresponds to a serving cell with index 1, and so on, and a bit that corresponds to an SpCell in a bit string corresponding to one logical channel associated with the packet duplication bearer is set to 0; and transmitting data for the logical channel on the cell corresponding to the bit set to 0 in the bit string corresponding thereto.

### TECHNICAL FIELD

The present disclosure relates to the technical field of wireless communications, and more particularly, relates to a base station, user equipment, and a related method for configuring a cell restricted for a logical channel associated with a packet duplication bearer.

### BACKGROUND

A new research project on 5G technical standards (see non-patent literature: RP-160671: New SID Proposal: Study on New Radio Access Technology) was proposed by NTT DOCOMO at the 3rd Generation Partnership Project (3GPP) RAN #71 plenary meeting held in March 2016, and was approved. The goal of the research project is to develop a New Radio (NR) access technology to meet all of the application scenarios, requirements, and deployment environments of 5G. NR mainly has three application scenarios: Enhanced Mobile Broadband Communications (eMBB), massive Machine Type Communications (mMTC), and Ultra Reliable and Low Latency Communications (URLLC).

In the 3GPP RAN2 #96 meeting held in October 2016, it was agreed that research will be performed on multi-connectivity (including dual-connectivity) so as to satisfy the reliability requirements of URLLC. The multi-connection may adopt mechanisms such as packet duplication or link selection. In the 3GPP NR AdHoc meeting held in January 2017, it was agreed that an NR-PDCP entity supports a packet duplication function of a user plane and a control plane, where the function of a PDCP entity at the transmitting end is to support packet duplication, while the function of a PDCP entity at the receiving end is to support deletion of duplicate packets. In the 3GPP RAN2 #97 meeting held in February 2017, it was agreed that both uplink and downlink support that in carrier aggregation, packet duplication uses a Packet Data Convergence Protocol (PDCP) packet data unit (PDU) and/or service data unit (SDU) for transmission on two or more logical channels and causes duplicate PDCP PDUs to be transmitted through different carriers. In the 3GPP RAN2 #98 meeting held in April 2017, it was agreed that in Radio Resource Control (RRC) configuration, two duplicate logical channels are mapped to different carriers, that is, duplicate logical channels cannot be mapped to the same carrier.

It is desired to resolve problems related to configuring a cell restricted for a logical channel associated with a packet duplication bearer in carrier aggregation or multi-connectivity scenarios.

### SUMMARY OF INVENTION

According to a first aspect of the present disclosure, provided is a method in user equipment, including: receiving an RRC message for a cell restricted for a logical channel associated with a packet duplication bearer, where the cell restricted for the logical channel associated with the packet duplication bearer is indicated by an indicator of a data type of a bit string, the least significant bit of the bit string corresponds to a serving cell with index 0, and the next bit corresponds to a serving cell with index 1, and so on, and a bit that corresponds to an SpCell in a bit string corresponding to one logical channel associated with the packet duplication bearer is set to 0; and transmitting data for the logical channel on the cell corresponding to the bit set to 0 in the bit string corresponding thereto.

In an embodiment, the packet duplication bearer is a packet duplication signaling radio bearer (SRB) using carrier aggregation.

According to a second aspect of the present disclosure, provided is user equipment (UE), including a transceiver, a processor, and a memory, the processor storing instructions executable by the processor to cause the UE to perform the method according to the above first aspect.

According to a third aspect of the present disclosure, provided is a method in a base station, including: transmitting to user equipment an RRC message for a cell restricted for a logical channel associated with a packet duplication bearer, where the cell restricted for the logical channel associated with the packet duplication bearer is indicated by an indicator of a data type of a bit string, the least significant bit of the bit string corresponds to a serving cell with index 0, and the next bit corresponds to a serving cell with index 1, and so on, and a bit that corresponds to an SpCell in a bit string corresponding to one logical channel associated with the packet duplication bearer is set to 0; and transmitting data for the logical channel on the cell corresponding to the bit set to 0 in the bit string corresponding thereto.

In an embodiment, the packet duplication bearer is a packet duplication signaling radio bearer (SRB) using carrier aggregation.

According to a fourth aspect of the present disclosure, provided is a base station, including a transceiver, a processor, and a memory, the processor storing instructions executable by the processor to cause the base station to perform the method according to the above third aspect.

### BRIEF DESCRIPTION OF THE DRAWINGS

The above and other features of the present disclosure will become more apparent with the following detailed description in conjunction with the accompanying drawings.

FIG. 1 is a schematic diagram illustrating data transmission of a packet duplication split DRB;

FIG. 2 is another schematic diagram illustrating data transmission of a packet duplication split DRB;

FIG. 3 is a schematic diagram of a protocol architecture of a packet duplication bearer in a carrier aggregation scenario;

FIG. 4 is a schematic diagram of a protocol architecture of a packet duplication split bearer in a dual-connectivity scenario;

FIG. 5 is a flowchart of a method in a base station according to an embodiment of the present disclosure.

FIG. 6 is a block diagram of a base station according to an embodiment of the present disclosure.

FIG. 7 is a flowchart of a method in user equipment according to an embodiment of the present disclosure.

FIG. 8 is a block diagram of user equipment according to an embodiment of the present disclosure.

### DETAILED DESCRIPTION

The following describes the present disclosure in detail with reference to the accompanying drawings and specific embodiments. It should be noted that the present disclosure should not be limited to the specific embodiments described below. In addition, for simplicity, detailed description of the prior art not directly related to the present disclosure is omitted to prevent confusion in understanding the present disclosure.

Some terms related to the present disclosure are described below. Unless otherwise specified, the terms related to the present disclosure use the definitions herein. The terms given in the present disclosure may be named differently in NR, LTE, and eLTE, but unified terms are used in the present disclosure. When applied to a specific system, the terms may be replaced with terms used in the corresponding system.

RRC: Radio Resource Control.

SDAP: Service Data Adaptation Protocol.

PDCP: Packet Data Convergence Protocol. In the present disclosure, unless otherwise specified, the PDCP may represent a PDCP in NR or LTE or eLTE.

RLC: Radio Link Control. In the present disclosure, unless otherwise specified, the RLC may represent RLC in NR or LTE or eLTE.

MAC: Medium Access Control. In the present disclosure, unless otherwise specified, the MAC may represent MAC in NR or LTE or eLTE.

DTCH: Dedicated Traffic Channel.

CCCH: Common Control Channel.

DCCH: Dedicated Control Channel.

PDU: Protocol Data Unit.

SDU: Service Data Unit.

In the present disclosure, data received from or transmitted to an upper layer is referred to as an SDU, and data transmitted to or received from a lower layer is referred to as a PDU. For example, data received from or transmitted to an upper layer by a PDCP entity is referred to as a PDCP SDU; and data received from or transmitted to an RLC entity by the PDCP entity is referred to as a PDCP PDU (i.e., an RLC SDU).

Master Base Station: Master eNB, denoted as MeNB (a base station corresponding to E-UTRAN or LTE or eLTE) or MgNB (a base station corresponding to 5G-RAN or NR). It refers to a base station that at least terminates at a control node mobility management entity (which can be denoted as S1-MME) for processing interaction between UE and a core network in multi-connectivity. In the present disclosure, master base stations are all denoted as MeNBs. It should be noted that all embodiments or definitions applicable to the MeNB are also applicable to the MgNB.

Secondary Base Station: Secondary eNB, denoted as SeNB (a base station corresponding to E-UTRAN or LTE or eLTE) or SgNB (a base station corresponding to 5G-RAN or NR), which refers to a base station that provides additional radio resources for UE but does not serve as an MeNB in multi-connectivity. In the present disclosure, secondary base stations are all denoted as SeNBs. It should be noted that all embodiments or definitions applicable to the SeNB are also applicable to the SgNB.

Primary Cell: PCell. The PCell is a cell that operates on the primary frequency, and is a cell on which UE performs an initial connection establishment procedure or initiates a connection reestablishment procedure or which is designated as a primary cell during a handover procedure. The cell defined in the present disclosure may also be referred to as a carrier.

Primary Secondary Cell: PSCell. The PSCell indicates, to UE in a procedure of performing an SCG change, an SCG cell for performing random access or performing initial PUSCH transmission when random access is skipped.

In the present disclosure, an SpCell refers to a PCell and/or a PSCell.

Secondary Cell: SCell. The SCell is a cell that operates at a secondary frequency. The cell can be configured after an RRC connection is established and can be used to provide additional radio resources.

Cell Group (CG): a group of serving cells or carriers associated with a master base station or secondary base station in multi-connectivity.

Master Cell Group (MCG): For UE not configured with multi-connectivity, the MCG consists of all serving cells. For UE configured with multi-connectivity, the MCG includes a subset of serving cells (i.e., a group of serving cells associated with an MeNB or MgNB) including a PCell and zero, one, or a plurality of SCells.

Secondary Cell Group (SCG): For UE configured with dual-connectivity, the SCG is a subset of serving cells not part of an MCG. The SCG includes one PSCell and zero or one or a plurality of SCells.

Multi-Connectivity: an operation mode of UE in an RRC connected state (RRC CONNECTED). In the multi-connectivity, a plurality of cell groups are configured, and the plurality of cell groups include one MCG and one or a plurality of SCGs (that is, the UE is connected to a plurality of base stations). If only one MCG (or MeNB or MgNB) and one SCG (or SeNB or SgNB) are configured, then the multiple connectivity is referred to as dual connectivity. That is, the UE in the connected state and having a plurality of receivers and/or transmitters is configured to use EUTRAN and/or 5G-RAN radio resources provided by a plurality of different schedulers; the schedulers may be connected by non-ideal backhaul or ideal backhaul. The multi-connectivity defined in the present disclosure includes dual-connectivity. Multi-connectivity data transmission modes include, but are not limited to, packet duplication and link selection.

DRB: Data Radio Bearer carrying user plane data, also referred to as a data bearer for short.

SRB: Signaling Radio Bearer. The bearer may be used for transmitting an RRC message and a NAS message or for transmitting only an RRC message and a NAS message. The SRB may comprise SRB0, SRB1, SRB1bis, and SRB2. SRB0 is used for an RRC message using a CCCH logical channel; SRB1 is used for an RRC message using a DCCH logical channel, where the RRC message may include a NAS message; SRB1 is also used for transmitting a NAS message before SRB2 is established. SRB1bis is used for an RRC message and a NAS message using a DCCH logical channel prior to secure activation, where the RRC message may include a NAS message. SRB2 is used for an RRC message and a NAS message using a DCCH logical channel, where the RRC message comprises recorded measurement information (or referred to as a measurement log).

The bearer defined in the present disclosure can be either a DRB or an SRB.

Split DRB: a bearer, in dual-connectivity or multi-connectivity, of which a wireless protocol is located in an MeNB (or MgNB) and an SeNB (or SgNB) and which uses resources of both the MeNB (or MgNB) and the SeNB (or SgNB). If a PDCP entity of the split DRB is located in a master base station (namely, data arrives at the master base station first and is forwarded by the master base station to a secondary base station to split the data in the master base station), then the split DRB is referred to as an MCG split DRB; if a PDCP entity of the split DRB is located in a secondary base station (namely, data arrives at the secondary base station first and is forwarded by the secondary base station to a master base station to split the data in the secondary base station), then the split DRB is referred to as an SCG split DRB. Unless otherwise specified, the split DRB in the present disclosure may be an MCG split DRB or an SCG split DRB. The embodiment of the present disclosure is also applicable to scenarios in which an MCG split DRB and an SCG split DRB are not distinguished, namely, the split DRB is a bearer DRB of which a wireless protocol is located in an MeNB (or MgNB) and an SeNB (or SgNB) and which uses resources of both the MeNB (or MgNB) and the SeNB (or SgNB).

Split SRB: a bearer, in multi-connectivity, of which a wireless protocol is located in an MeNB (or MgNB) and an SeNB (or SgNB) and which uses resources of both the MeNB (or MgNB) and the SeNB (or SgNB). If a PDCP entity and/or RRC of the split SRB is located in a master base station (namely, signaling, also referred to as data, is forwarded by the master base station to a secondary base station to split the signaling in the master base station), then the split SRB is referred to as an MCG split SRB; if a PDCP entity and/or RRC of the split SRB is located in a secondary base station (namely, signaling, also referred to as data, is forwarded by the secondary base station to a master base station to split the signaling in the secondary base station), then the split SRB is referred to as an SCG split SRB. Unless otherwise specified, the split SRB in the present disclosure may be an MCG split SRB or an SCG split SRB. The embodiment of the present disclosure is also applicable to scenarios in which an MCG split SRB and an SCG split SRB are not distinguished, namely, the split SRB is a bearer SRB of which a wireless protocol is located in an MeNB (or MgNB) and an SeNB (or SgNB) and which uses resources of both the MeNB (or MgNB) and the SeNB (or SgNB).

The split bearer defined in the present disclosure can be either a split SRB or a split DRB.

Packet Duplication: also referred to as PDCP duplication (unless otherwise specified, the data in the present disclosure may be control plane signaling or user plane data, which respectively correspond to signaling of an SRB and data of a DRB). In a dual-connectivity or multi-connectivity mode, the same data (or referred to as a packet, i.e., a PDCP PDU or PDCP SDU) is transmitted in serving cells of a plurality of CGs, i.e., the same data is transmitted by using resources provided by both a master base station (or an MCG) and a secondary base station (or an SCG); or, the same data is transmitted respectively to lower layers (or RLC layers) located at the MCG and the SCG; or, a PDCP entity transmits the same PDCP PDU to a plurality of associated lower-layer entities (or RLC entities); or, the same data is transmitted on a plurality of different bearers. In a carrier aggregation or single-connectivity mode, a PDCP entity transmits duplicate (or the same) PDCP PDUs to two or more associated RLC entities (or referred to as lower-layer entities) and/or logical channels, and a MAC entity transmits the PDCP PDUs to a receiving end through different carriers (also referred to as cells or serving cells) or carrier groups; a PDCP entity at the receiving end is responsible for monitoring and deletion of the duplicate PDCP PDUs or SDUs. In other words, when PDCP duplication is activated, the PDCP entity duplicates a PDCP PDU and delivers the duplicated PDCP PDUs to two associated lower-layer entities (i.e., RLC entities). Optionally, the PDCP entity duplicates only a PDCP data PDU, and a PDCP control PDU is delivered to only one lower-layer entity.

Packet Duplication Bearer: a bearer configured with PDCP duplication in a carrier aggregation or single-connectivity mode, including a packet duplication SRB and a packet duplication DRB. One PDCP entity of the bearer is associated with two or more RLC entities, and the two or more RLC entities are further each associated with one logical channel, and a PDCP PDU from the PDCP entity is transmitted to a MAC entity through these logical channels. A PDCP entity at the transmitting end transmits duplicated (or the same) PDCP PDUs to the two or more RLC entities (or referred to as lower-layer entities) and/or two or more logical channels, and a MAC entity transmits the PDCP PDUs to a receiving end through different carriers (i.e., cells or serving cells); a PDCP entity at the receiving end deletes the duplicated PDCP PDUs or SDUs from the lower-layer entities. The packet duplication bearer is also referred to as a PDCP duplication bearer, which is a bearer configured with PDCP duplication. The packet duplication bearer may be an MCG packet duplication bearer or may be an SCG packet duplication bearer.

Packet Duplication Split Bearer: a split bearer configured with PDCP duplication in a dual-connectivity or multi-connectivity mode, including a packet duplication split SRB and a packet duplication split DRB. In the transmission mode, the same data is transmitted over a plurality of wireless protocols of the split bearer. The packet duplication split bearer refers to a split bearer configured with PDCP duplication.

It is to be noted that unless otherwise specified, the term “packet duplication bearer” used in the following embodiments of the present disclosure includes the aforementioned packet duplication bearer and packet duplication split bearer.

logicalChannelIdentity information element: a logical channel identity.

logicalChannelConfig information element: including parameters used for configuring a logical channel.

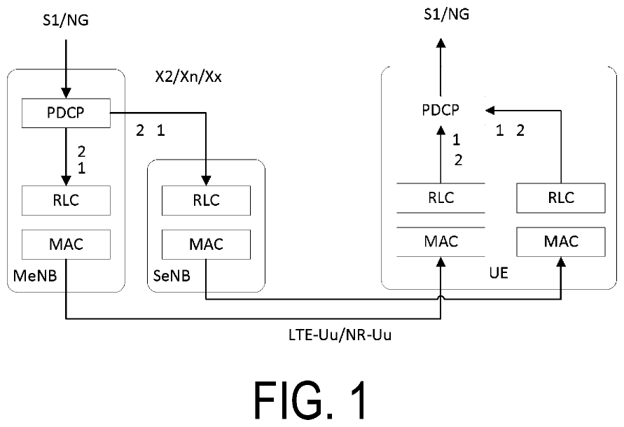

FIG. 1 is a schematic diagram illustrating downlink transmission of a packet duplication split DRB between a base station and user equipment (UE) in dual-connectivity (a network-side PDCP entity is included in an MCG). It should be understood that uplink transmission of the packet duplication split DRB between the base station and the UE may adopt the same protocol architecture, except that data is transmitted from the UE to the base station, that is, the arrows in FIG. 1 are reversed. As shown in FIG. 1, data (for example, a Packet Data Convergence Protocol protocol data unit (PDCP PDU)) is transmitted over a plurality of wireless protocols (corresponding to a plurality of RLC entities associated with the same PDCP entity) of the split DRB by using resources of an MeNB and an SeNB. In a multi-connectivity mode supporting packet duplication, each PDCP PDU of the packet duplication split DRB is transmitted to a receiving party via a plurality of RLC entities. An interface between the MeNB and the SeNB may be denoted as Xn or Xx or X2. The interface may be named differently according to different types of the MeNB and the SeNB. For example, the interface is denoted as Xx if the MeNB is an LTE eNB and the SeNB is a gNB; or the interface is denoted as Xn if the MeNB is a gNB and the SeNB is an eLTE eNB. Correspondingly, a packet duplication split SRB adopts a similar protocol architecture, except that for a corresponding split SRB, an upper-layer entity of a PDCP entity is an RRC, and the PDCP entity receives data from the RRC entity and transmits data to the RRC entity after receiving the data from a lower-layer entity.

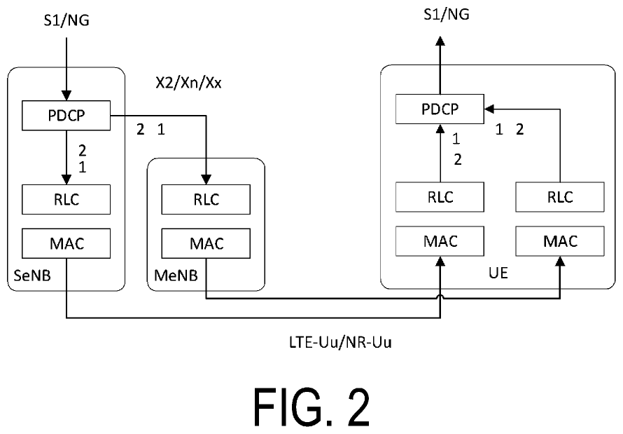

FIG. 2 is another schematic diagram illustrating downlink transmission of a packet duplication split DRB between a base station and user equipment (UE) in dual-connectivity (a network-side PDCP entity is included in an SCG). It should be understood that uplink transmission of the packet duplication split DRB between the base station and the UE may adopt the same protocol architecture, except that data is transmitted from the UE to the base station, that is, the arrows in FIG. 2 are reversed. As shown in FIG. 2, data (e.g., a PDCP PDU) is transmitted over a plurality of wireless protocols (corresponding to a plurality of RLC entities associated with the same PDCP entity) of the split DRB by using resources of an MeNB and an SeNB. In a multi-connectivity mode supporting packet duplication, each PDCP PDU of a packet duplication split DRB is transmitted to a receiving party via a plurality of RLC entities. An interface between the MeNB and the SeNB may be denoted as Xn or Xx or X2. The interface may be named differently according to different types of the MeNB and the SeNB. For example, the interface is denoted as Xx if the MeNB is an LTE eNB and the SeNB is a gNB; or the interface is denoted as Xn if the MeNB is a gNB and the SeNB is an eLTE eNB. Accordingly, a packet duplication split SRB adopts a similar protocol architecture, except that an upper-layer entity of a PDCP entity is an RRC, and the PDCP entity receives data from the RRC entity and transmits data to the RRC entity after receiving the data from a lower-layer entity.

Some embodiments of the present disclosure use a scenario where a DCP PDU is repeatedly transmitted twice as an example (i.e., one PDCP entity is associated with two RLC entities and/or two logical channels). However, the technical solution described in the present disclosure is not limited to the scenario of repeatedly transmitting a data packet PDCP PDU or SDU twice, and those skilled in the art could easily extend the technical solution to scenarios of repeatedly transmitting a data packet a plurality of times (that is, one PDCP entity or one bearer is associated with a plurality of RLC entities and/or a plurality of logical channels).

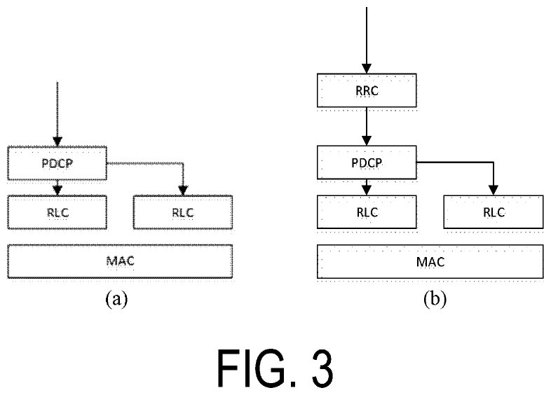

FIG. 3 is a schematic diagram of a protocol architecture of a packet duplication bearer in a carrier aggregation scenario. In the schematic diagram shown in FIG. 3(a), a PDCP entity of a DRB is associated with two RLC entities and two logical channels, and one MAC entity. In the schematic diagram shown in FIG. 3(b), an RRC entity and a PDCP entity of an SRB are associated with two RLC entities and two logical channels, and one MAC entity.

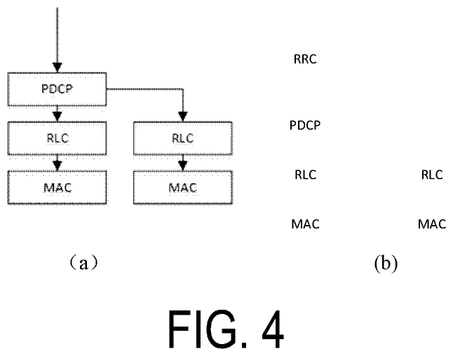

FIG. 4 is a schematic diagram of a protocol architecture of a packet duplication split bearer in a dual-connectivity scenario. In the schematic diagram shown in FIG. 4(a), a PDCP entity of a packet duplication split DRB is associated with two RLC entities and two logical channels, and two MAC entities. In the schematic diagram shown in FIG. 4(b), an RRC entity and a PDCP entity of a packet duplication split SRB are associated with two RLC entities and two logical channels, and two MAC entities.

It should be noted that in NR, an upper-layer entity of a PDCP entity of a DRB or a split DRB is an SDAP entity.

The following provides embodiments in which a base station configures a cell restricted for a logical channel associated with a packet duplication bearer for user equipment (UE).

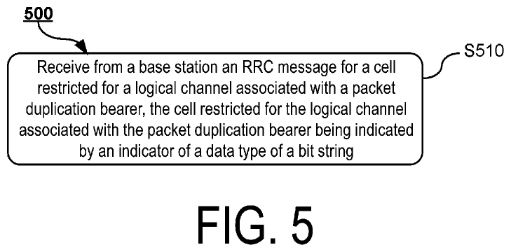

FIG. 5 illustrates a flowchart of a method 500 in user equipment (UE) according to an embodiment of the present disclosure. As shown in the figure, the method 500 includes the following steps.

In step S510, an RRC message for a cell restricted for a logical channel associated with a packet duplication bearer is received from a base station. The cell restricted for the logical channel associated with the packet duplication bearer is indicated by an indicator lch-CellRestriction of a data type of a bit string (BIT STRING). The least significant bit of the indicator or the bit string corresponding thereto corresponds to a cell with index 0, and the next bit corresponds to a cell with index 1, and so on. A bit that corresponds to an SpCell in a bit string corresponding to one logical channel associated with the packet duplication bearer is set to 0. Data for the logical channel is transmitted on the cell corresponding to the bit set to 0 in the bit string corresponding thereto.

In other words, the radio resource control (RRC) message is received from the base station, and the RRC message includes a configuration for the cell restricted for the logical channel associated with the packet duplication bearer. Specifically, the RRC message includes an indicator lch-CellRestriction for indicating the cell restricted for the corresponding logical channel. The RRC message may be an RRC reconfiguration message. The packet duplication bearer may be an SRB configured with packet duplication in carrier aggregation, that is, the SRB configured with packet duplication uses carrier aggregation (CA) or operates in a carrier aggregation mode.

Specifically, this indicator lch-CellRestriction is included in an information element LogicalChannelConfig for configuring a logical channel parameter in the RRC message, and the logical channel corresponding to the indicator is a logical channel defined by the information element LogicalChannelConfig including the indicator. Table 1 exemplarily describes parameters included in the information element LogicalChannelConfig. Unless otherwise specified, the specific description of the parameters in the table can be found in 3GPP technical document TS36.331. The indicator lch-CellRestriction is used to indicate a cell which is restricted for the corresponding logical channel. The indicator lch-CellRestriction corresponds to a bit string (BIT STRING), i.e., the value (also referred to as data type) of the indicator lch-CellRestriction is a bit string. Each bit in the bit string corresponds to a cell, and the meaning of the value of each bit and a correspondence between the bit and the cell are described as follows: For each cell, if the cell is a cell restricted for the corresponding logical channel, a bit corresponding thereto is set to 1; if the cell is not a cell restricted for the corresponding logical channel, the bit corresponding thereto is set to 0. The least significant bit of the bit string (referred to as bit 0) corresponds to a serving cell with index 0, and the next bit (referred to as bit 1) corresponds to a serving cell with index 1, and so on. If a cell is restricted for the corresponding logical channel, then data of the logical channel is not allowed to be transmitted using that cell. In other words, if a logical channel has been configured with the indicator lch-CellRestriction, for this logical channel, a MAC entity shall not consider the cell indicated by lch-CellRestriction to be restricted for transmission. For data from a logical channel, the data is transmitted on a cell corresponding to a bit with a value of 0 in a bit string corresponding thereto. In other words, for data from a logical channel, the data is not transmitted on a cell corresponding to a bit with a value of 1 in a bit string corresponding thereto.

The following specifically describes a manner for restricting a SpCell for a logical channel associated with a packet duplication bearer.

For a bearer configured with PDCP duplication (i.e., a packet duplication bearer), an SpCell (i.e., a PCell and/or a PSCell) cannot be restricted for two logical channels of the packet duplication bearer at the same time, or the SpCell cannot be a cell restricted for the two logical channels of the packet duplication bearer at the same time, or the SpCell is not a cell restricted for one of the logical channels of the packet duplication bearer. Alternatively, for the bearer configured with PDCP duplication, the values of the least significant bits of bit strings corresponding to the logical channels associated with the packet duplication bearer cannot be 1 at the same time, or bits in the bit strings corresponding to the logical channels of the packet duplication bearer that correspond to the SpCell (i.e., the PCell and/or the PSCell) cannot have the value of 1 at the same time. Alternatively, for the bearer configured with PDCP duplication, one of the least significant bits of the bit strings corresponding to the logical channels of the packet duplication bear has the value of 0, or one of the bits in the bit strings corresponding to the logical channels of the packet duplication bear that correspond to the SpCell (i.e., the PCell and/or the PSCell) has the value of 0. Alternatively, for the bearer configured with PDCP duplication, one of the logical channels of the packet duplication bearer does not restrict the SpCell (i.e., the PCell and/or the PSCell).

The following describes in detail a manner for restricting a SpCell for a logical channel associated with a packet duplication bearer that uses carrier aggregation.

If a packet duplication bearer uses carrier aggregation or operates in a carrier aggregation mode (for example, as shown in FIG. 3b), then an SpCell (i.e., a PCell and/or a PSCell) cannot be restricted for two logical channels of the packet duplication bearer at the same time, or the SpCell cannot be a cell restricted for the two logical channels of the packet duplication bearer at the same time, or the SpCell is not a cell restricted for one of the logical channels of the packet duplication bearer. Alternatively, if the packet duplication bearer uses carrier aggregation or operates in the carrier aggregation mode, then the values of the least significant bits of bit strings corresponding to the logical channels associated with the packet duplication bearer cannot be 1 at the same time, or bits in the bit strings corresponding to the logical channels of the packet duplication bearer that correspond to the SpCell (i.e., the PCell and/or the PSCell) cannot have the value of 1 at the same time. Alternatively, if the packet duplication bearer uses carrier aggregation or operates in the carrier aggregation mode, then one of the least significant bits of the bit strings corresponding to the logical channels of the packet duplication bear has the value of 0, or one of the bits in the bit strings corresponding to the logical channels of the packet duplication bear that correspond to the SpCell (i.e., the PCell and/or the PSCell) has the value of 0. Alternatively, if the packet duplication bearer uses carrier aggregation or operates in the carrier aggregation mode, then one of the logical channels of the packet duplication bearer does not restrict the SpCell (i.e., the PCell and/or the PSCell).

Specifically, for an SRB configured with PDCP duplication, if the SRB configured with PDCP duplication uses carrier aggregation or operates in a carrier aggregation mode (for example, an MCG SRB configured with PDCP duplication or an SCG SRB configured with PDCP duplication), then an SpCell (i.e., a PCell and/or a PSCell) cannot be restricted for two logical channels of the SRB configured with PDCP duplication at the same time, or the SpCell cannot be a cell restricted for the two logical channels of the SRB configured with PDCP duplication at the same time, or the SpCell is not a cell restricted for one of the logical channels of the SRB configured with PDCP duplication. Alternatively, if the SRB configured with PDCP duplication uses carrier aggregation or operates in the carrier aggregation mode, then the values of the least significant bits of bit strings corresponding to the logical channels associated with the SRB configured with PDCP duplication cannot be 1 at the same time, or bits in the bit strings corresponding to the logical channels of the SRB configured with PDCP duplication that correspond to the SpCell (i.e., the PCell and/or the PSCell) cannot have the value of 1 at the same time. Alternatively, if the SRB configured with PDCP duplication uses carrier aggregation or operates in the carrier aggregation mode, then one of the least significant bits of the bit strings corresponding to the logical channels of the SRB configured with PDCP duplication has the value of 0, or one of the bits in the bit strings corresponding to the logical channels of the SRB configured with PDCP duplication that correspond to the SpCell (i.e., the PCell and/or the PSCell) has the value of 0. Alternatively, if the SRB configured with PDCP duplication uses carrier aggregation or operates in the carrier aggregation mode, then one of the logical channels of the SRB configured with PDCP duplication does not restrict the SpCell (i.e., the PCell and/or the PSCell).

If the SpCell (i.e., the PCell and/or the PSCell) is restricted for the two logical channels of the SRB configured with PDCP duplication, then when both RLC entities associated with the two logical channels reach a maximum number of retransmissions, a failure information procedure will be initiated to report an RLC failure of type duplication, that is, transmitting a FailureInformation message, which includes a logical channel identity logicalChannelIdentity of a corresponding RLC entity and a cell group indication cellGroupIndication of a cell group where the RLC entity is located, where cellGroupIndication indicates the cell group where the RLC entity encountering the PDCP duplication failure is located is an MCG or an SCG. When the value of cellGroupIndication is mn, the MCG is indicated, and when the value of cellGroupIndication is sn, the SCG is indicated. However, because the two RLC entities associated with that SRB are both invalid, the FailureInformation message cannot be transmitted to an E-UTRAN. Therefore, for the SRB configured with PDCP duplication, one of the logical channels of the SRB must not restrict the SpCell (i.e., the PCell and/or the PSCell), or the SpCell is a cell not restricted for one of the logical channels of the SRB.

In the foregoing embodiment, a scenario where the SRB configured with PDCP duplication is configured with two logical channels is used as an example. If the SRB can be configured with a plurality of logical channels, one of the logical channels cannot restrict an SpCell, i.e., a corresponding bit value is 0. In addition, in the present disclosure, if a bit in a bit string of a certain logical channel of a packet duplication SRB that corresponds to a serving cell is set to 0, then bits in bit strings of the other logical channels of the SRB that correspond to that serving cell can only set to 1 in order to prevent data from different logical channels of the same SRB from being transmitted on the same serving cell.

In the present disclosure, unless otherwise specified, the identity of a cell refers to ServCellIndex corresponding to the cell. ServCellIndex concerns a short identity for identifying a serving cell (i.e., a PCell and an SCell). 0 is applied to the PCell (that is, the identity of the PCell is 0), and SCellIndex allocated to the SCell is applied to the SCell, that is, the identity of the SCell is SCellIndex. SCellIndex concerns a short identity for identifying an SCell. In addition, a cell restricted for a logical channel is only valid when PDCP duplication is activated. After PDCP duplication is activated, a PDCP entity submits a duplicate of a PDCP PDU to a lower layer.

TABLE 1
LogicalChannelConfig information element and parameters included therein
LogicalChannelConfig information element

-- ASN1START

| | |
|---|---|
| LogicalChannelConfig ::= | SEQUENCE { |

| ul-SpecificParameters | | SEQUENCE { |
|---|---|---|
| | priority | INTEGER (1..16), |
| | prioritisedBitRate | ENUMERATED { |

```
    kBps0, kBps8, kBps16, kBps32, kBps64, kBps128,
    kBps256, infinity, kBps512-v1020,
```

kBps1024-v1020,

| | kBps2048-v1020, spare5, spare4, spare3, spare2, | | |
|---|---|---|---|
| | spare1}, | | |
| bucketSizeDuration | ENUMERATED { | | |
| | ms50, ms100, ms150, ms300, ms500, ms1000, spare2, | | |
| | spare1}, | | |
| logicalChannelGroup | INTEGER (0..3) | OPTIONAL | -- Need |

OR

| | | |
|---|---|---|
| } | OPTIONAL, | -- Cond |

UL
...,

| | | | | |
|---|---|---|---|---|
| [[ | logicalChannelSR-Mask-r9 | ENUMERATED {setup} | OPTIONAL | -- Cond |

SRmask
]],

| | | | | |
|---|---|---|---|---|
| [[ | logicalChannelSR-Prohibit-r12 | BOOLEAN | OPTIONAL | -- Need ON |

]],

| | | | | |
|---|---|---|---|---|
| [[ | laa-UL-Allowed-r14 | BOOLEAN | OPTIONAL, | -- Need ON |

| | |
|---|---|
| bitRateQueryProhibitTimer-r14 | ENUMERATED { |

| s0, s0dot4, s0dot8, s1dot6, s3, s6, s12, | | |
|---|---|---|
| s30} | OPTIONAL | --Need OR |

]],

| | | |
|---|---|---|
| [[ | allowedTTI-Lengths-r15 | CHOICE { |

| | |
|---|---|
| release | NULL, |
| setup | SEQUENCE { |

| | |
|---|---|
| shortTTI-r15 | BOOLEAN, |
| subframeTTI-r15 | BOOLEAN |

| } | | |
|---|---|---|
| } | OPTIONAL, | -- Need |

ON

| logicalChannelSR-Restriction-r15 CHOICE { | |
|---|---|
| release | NULL, |
| setup | ENUMERATED {spucch, pucch} |

| | | |
|---|---|---|
| } | OPTIONAL, | -- Need |

ON

| channellAccessPriority-r15 | CHOICE { | |
|---|---|---|
| release | NULL, | |
| setup | INTEGER (1..4) | |
| } | OPTIONAL, | -- Need ON |

| | |
|---|---|
| lch-CellRestriction-r15 | BIT STRING (SIZE (maxServCell-r13)) OPTIONAL -- Need |

ON
]]
}
-- ASN1STOP

It should be noted that, in the present disclosure, a logical channel associated with a packet duplication bearer is (i.e., corresponds to) a logical channel of the packet duplication bearer or a logical channel configured for the packet duplication bearer, as shown in FIGS. 3(a), 3(b), 4(a), and 4(b).

In the present invention, a cell restricted for a logical channel is (i.e., corresponds to) a cell restricted for an RLC entity associated with the logical channel, which are equivalent descriptions.

A configuration for a cell restricted for a logical channel associated with each packet duplication bearer is separately provided. For example, a restricted cell is separately configured for a logical channel of each packet duplication bearer, that is, different restricted cells are configured for logical channels (or RLC entities) from different packet duplication bearers. In the embodiments of the present disclosure, a configuration for a cell restricted for a logical channel is bearer-specific. The base station needs to configure a restricted cell for each logical channel of each packet duplication bearer in the UE, that is, each logical channel is associated with one indicator for indicating a cell restricted for the logical channel.

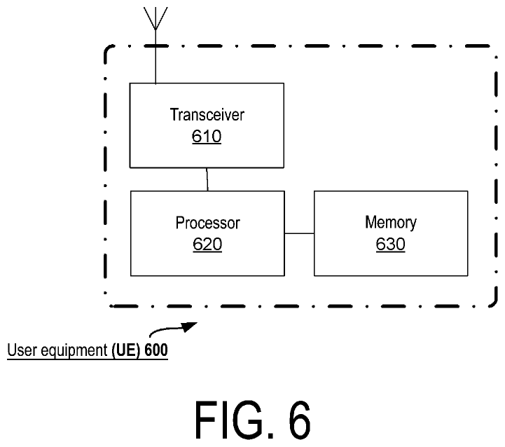

The present disclosure provides user equipment (UE) corresponding to the method 500 described above. FIG. 6 is a block diagram of UE 600 according to an embodiment of the present disclosure. As shown in the figure, the UE 600 comprises a transceiver 610, a processor 620, and a memory 630. The processor 630 stores instructions executable by the processor 620 to cause the UE 600 to perform the method 500 described above with reference to FIG. 5.

Specifically, the processor 630 stores the instructions executable by the processor 620, so that the UE 600 is caused to receive from a base station an RRC message for a cell restricted for a logical channel associated with a packet duplication bearer, where the cell restricted for the logical channel associated with the packet duplication bearer is indicated by an indicator of a data type of a bit string, the least significant bit of the bit string corresponds to a serving cell with index 0, and the next bit corresponds to a serving cell with index 1, and so on, and a bit that corresponds to an SpCell in a bit string corresponding to one logical channel associated with the packet duplication bearer is set to 0; and data for the logical channel is transmitted on the cell corresponding to the bit set to 0 in the bit string corresponding thereto.

In one example, the packet duplication bearer is a packet duplication signaling radio bearer (SRB) using carrier aggregation.

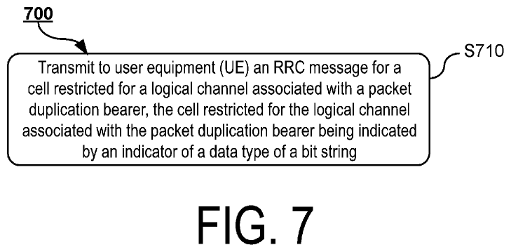

The present disclosure further provides a method used in a base station. FIG. 7 is a flowchart of a method 700 in a base station according to an embodiment of the present disclosure. As shown in the figure, the method 700 comprises the following steps.

In step S710, user equipment is provided with an RRC message for a cell restricted for a logical channel associated with a packet duplication bearer, where the cell restricted for the logical channel associated with the packet duplication bearer is indicated by an indicator of a data type of a bit string, the least significant bit of the bit string corresponds to a serving cell with index 0, and the next bit corresponds to a serving cell with index 1, and so on, and a bit that corresponds to an SpCell in a bit string corresponding to one logical channel associated with the packet duplication bearer is set to 0; and the user equipment transmits data for the logical channel on the cell corresponding to the bit set to 0 in the bit string corresponding thereto.

In one example, the packet duplication bearer is a packet duplication signaling radio bearer (SRB) using carrier aggregation.

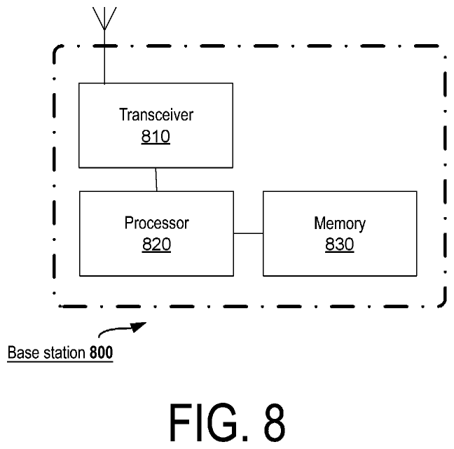

The present disclosure provides a base station corresponding to the method 700 described above. FIG. 8 illustrates a block diagram of a base station 800 according to an embodiment of the present disclosure. As shown in the figure, the base station 800 comprises a transceiver 810, a processor 820, and a memory 830. The processor 830 stores instructions executable by the processor 820 to cause the base station 800 to perform the method 700 described above with reference to FIG. 7.

Specifically, the processor 830 stores instructions executable by the processor 820, so that the base station 800 is caused to provide user equipment (UE) with an RRC message for a cell restricted for a logical channel associated with a packet duplication bearer, where the cell restricted for the logical channel associated with the packet duplication bearer is indicated by an indicator of a data type of a bit string, the least significant bit of the bit string corresponds to a serving cell with index 0, and the next bit corresponds to a serving cell with index 1, and so on, and a bit that corresponds to an SpCell in a bit string corresponding to one logical channel associated with the packet duplication bearer is set to 0; and the user equipment transmits data for the logical channel on the cell corresponding to the bit set to 0 in the bit string corresponding thereto.

In one example, the packet duplication bearer is a packet duplication signaling radio bearer (SRB) using carrier aggregation.

Regarding the configuration of the cell restricted for the logical channel associated with the packet duplication bearer, the various aspects, features, and examples described above with respect to the method 500 are also applicable to the UE 600, the method 700, and the base station 800.

The computer-executable instructions or program running on the device according to the present invention may be a program that enables the computer to implement the functions of the embodiments of the present invention by controlling the central processing unit (CPU). The program or information processed by the program may be temporarily stored in a volatile memory (for example, a random access memory (RAM)), a hard disk drive (HDD), a non-volatile memory (for example, a flash memory), or other memory systems.

The computer-executable instructions or program for implementing the functions of the embodiments of the present invention may be recorded on a computer-readable storage medium. The corresponding functions may be achieved by reading programs recorded on the recording medium and executing them by the computer system. The phrase “computer system” herein may be a computer system embedded in the device, which may include operating systems or hardware (e.g., peripherals). The “computer-readable storage medium” may be a semiconductor recording medium, an optical recording medium, a magnetic recording medium, a short-time dynamic memory program recording medium, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-6. (canceled)

7. A user equipment comprising:
receiving circuitry configured to receive an RRC message which includes a LogicalChannelConfig information element (IE) including an lch-CellRestriction IE used to indicate cells restricted for each logical channel, wherein a bit in the lch-CellRestriction IE is set to 0 or 1, and a bit corresponding to SpCell in the lch-CellRestriction IE for one of logical channels associated to an SRB configured with PDCP duplication is only set to 0; and
transmitting circuitry configured to transmit data for the logical channel on the cells whose corresponding bit in the lch-CellRestriction IE is set to 0.

8. A base station comprising:
transmitting circuitry configured to transmit an RRC message which includes a LogicalChannelConfig information element (IE) including an lch-CellRestriction IE used to indicate cells restricted for each logical channel, wherein a bit in the lch-CellRestriction IE is set to 0 or 1, and a bit corresponding to SpCell in the lch-CellRestriction IE for one of logical channels associated to an SRB configured with PDCP duplication is only set to 0; and
receiving circuitry configured to receive data for the logical channel on the cells whose corresponding bit in the lch-CellRestriction IE is set to 0.

9. A method at a base station comprising:
transmitting an RRC message which includes a LogicalChannelConfig information element (IE) including an lch-CellRestriction IE used to indicate cells restricted for each logical channel, wherein a bit in the lch-CellRestriction IE is set to 0 or 1, and a bit corresponding to SpCell in the lch-CellRestriction IE for one of logical channels associated to an SRB configured with PDCP duplication is only set to 0; and
receiving data for the logical channel on the cells whose corresponding bit in the lch-CellRestriction IE is set to 0.
